(19) United States
(12) Patent Application Publication
(10) Pub. No.: US 2015/0363787 A1
(43) Pub. Date: Dec. 17, 2015

(54) HANGOUT BASED VIDEO RESPONSE UNIT FOR CONTACT CENTERS

(71) Applicants: Juan Vasquez, Mountain View, CA (US); Steve Osborn, Mountain View, CA (US)

(72) Inventors: Juan Vasquez, Mountain View, CA (US); Steve Osborn, Mountain View, CA (US)

(73) Assignee: GOOGLE INC., Mountain View, CA (US)

(21) Appl. No.: 13/424,039

(22) Filed: Mar. 19, 2012

(51) Int. Cl. G06Q 30/00; G06F 3/00; H04N 7/14; H04L 29/06; H04L 29/08; G06F 15/16

(52) U.S. Cl. CPC G06Q 30/016; H04L 65/4069; H04L 67/141; H04L 67/16; H04N 7/141

(57) ABSTRACT

The present disclosure includes an apparatus and method for automated human-computer interaction. In some embodiments, the automated human-computer interaction occurs in a virtual environment and includes multimedia communications. Video, audio, and/or textual interactions are among the various forms of communication supported during the automated human-computer interaction. In some instances, the automated human-computer interaction occurs in a virtual environment to assist a customer during a customer service call.

### BACKGROUND

A contact center can act as a point-of-contact (POC) for a customer seeking assistance in relation to a product or service offered by a company or other entity. Contact centers typically rely on conventional communication systems. The back end of such systems can include platforms that provide resources such as telephonic connections to agents and interactive voice response systems (IVRs). The IVR units in such systems may extract attributes of a customer service request by interacting with the customer during an automated voice dialog. Conventional IVR units may use Voice Extensible Markup Language (VXML) to achieve interactive voice dialog with the customer. Based upon the auditory or dual-tone multi-frequency (DTMF) responses given by the customer during a given dialog, a VXML browser receives instructions to play back predetermined audio files to the customer. The customer listens to the audio playback and responds verbally or with a DTMF, repeating this cycle until the IVR unit transfers the customer to another contact center resource or until the customer service request terminates. Thus, conventional contact center platforms, which use conventional IVR units, are only equipped for automated audio interaction with customers during customer service requests.

Such systems have significant limitations, especially in connection with the quality and speed with which information may be communicated both to and from the customers. In many circumstances, customers attempt to short cut the systems by obtaining an agent through repeated pressing of the “0” key in standard touch tone telephones or repeated saying of “agent.” Customer satisfaction suffers. While others have attempted to improve such systems, there remains long standing problems associated with such systems. The POC, i.e., the contact center, is still often considered by customers to be unsatisfactory.

Recently, advances in technology have permitted the use of computers to provide written responses to requests for help. In such instances, the customer has to obtain computer access and navigate to the proper internet pages of the company or other entity providing service. The customer navigates to the proper help page where a menu driven help center is provided. Depending upon the selections made by the customer, written responses are provided. Such systems are rigid and also suffer from quality and speed to answer issues. Consequently, there is a need for improved point of contact mechanisms for providing customer service in efficient and meaningful manners.

### SUMMARY

The present disclosure includes an apparatus and method for automated human-computer interaction. An example embodiment describes a virtual server apparatus in connection over a communication network with a client device and providing multimedia content over the communication network to the client device upon request. The virtual server apparatus comprises a contact center manager connected to a client device over a communication network and receiving a resource request signal that indicates the client device requests to be provided resources and a reflector associated with a virtual hangout and connected to the contact center manager, the reflector connecting to the client device over the communication network.

The virtual server apparatus further comprises a multimedia resource connected to the contact center manager and being capable of connecting to the client device through the reflector and the communication network in such a manner that streaming content may be provided by the multimedia resource and displayed on the client device, and one or more graphical user selection options transmitted through the reflector and the communication network to the client device such that, when a particular one of the one or more graphical user selection options is selected on the client device, the multimedia resource receives a selection option signal indicative of the particular one of the one or more graphical user selection options chosen on the client device, wherein the streaming content provided by the multimedia resource and displayed on the client device is adjusted in response to the selection option signal.

In some instances, upon establishing a connection to the client device, the multimedia resource begins executing at least one set of instructions that include transferring a first multimedia data stream to the client device including the one or more graphical user selection options, receiving and analyzing a second multimedia data stream from the client device, wherein the second multimedia data stream includes data of one or more responses that are input at the client device one of verbally, textually, and tacitly, and modifying the first multimedia data stream based on the one or more responses that are input at the client device.

The at least one set of instructions may include a set of instructions for communicating with one or more client devices that do not support video content and/or a set of instructions for communicating with one or more client devices that support video content.

In some instances, video content includes at least one of archived video content and live video content. In other instances, video content includes both archived video content and live video content. Archived video content may include content supported by YouTube®.

Another embodiment describes a server system in a virtual computing environment for providing a video response resource over a multimedia stream to a client device. The server system comprises a server connected to a client device and providing a communication session between the client device and the server, a video response resource connected to the communication session, the video response resource capable of accessing stored video content and providing streaming video content to the communication session, the streaming video content being displayed on a graphical user interface residing on the client device, the streaming video content indicating a plurality of choices which are displayed upon the graphical user interface, the video response resource further receiving selections made on the graphical user interface that respond to the plurality of choices in the streaming video content, the video response resource adjusting the streaming video content in response to the selections.

Some embodiments may include graphical user interface that comprises a main video content portion, a selections portion, a menu option portion, and a text input portion. Another embodiment describes a method at a client device for interacting with a video response resource in a virtual computing environment supporting multimedia interaction comprising initiating a communication session between the client device and a server, the communication session being individualized to the client device, receiving a video response resource in the communication session, consuming streaming video content provided by the video response resource in the communication session, wherein the video content is one of archived video content, live video content, and a combination of archived and live video content, receiving a plurality of choices within the streaming video content, the plurality of choices provided by the video response resource, viewing the plurality of choices as a graphical user interface on the client device, and responding to the plurality of choices on the graphical user interface by providing input to the client device.

### BRIEF DESCRIPTION OF THE DRAWINGS

FIG. 1 is a block diagram of an example system supporting a multimedia production environment, including a plurality of client machines interacting through a common communications session hosted by a server resource;

FIG. 2 is a block diagram of basic functional components for one of the client machines in FIG. 1;

FIG. 3 is an application level block diagram of the client machine in FIG. 2, illustrating example executable components supporting at the client a group interaction experience within the multimedia production environment;

FIG. 4 is an example graphical user interface at the client machine of FIGS. 2 and 3 available to a user for the group interaction experience;

FIG. 5 is a block diagram of an application at the server of FIG. 1 that supports the multimedia production environment and interaction among the client machines through their respect graphical user interfaces;

FIG. 6 is block diagram illustrating one of the many resources available for use in a virtual hangout being used as a POC to assist a customer during a service request;

FIG. 7 is a block diagram illustrating one example of a GUI that is displayed by a VidRU in accordance with some embodiments;

FIG. 8 is a flow diagram describing a method of assisting a customer during a service request in a multimedia production environment using the VidRU described in FIGS. 6 and 7.

### DETAILED DESCRIPTION OF EXAMPLE EMBODIMENTS

In an example embodiment, a contact center platform establishes one or more multimedia communications sessions (“virtual hangouts”) with customers in a multimedia production environment and transfers contact center resources to the multimedia communications sessions. One example of a multimedia production environment is the Google+ hangout environment. A customer initiates a service request by calling a contact center that is associated with a product or service that the customer is using. The contact center places the customer in a multimedia communications session, where the customer may interact with contact center resources. Attributes of the customer service request may be gathered and delivered to a Contact Center Manager (CCM), which monitors the interaction and delivers contact center resources on-demand and in real-time. Resources may be delivered to and removed from the multimedia communications session in parallel based upon the needs and complexity of the service request. Additionally, once an interaction has been established, it may not be necessary to transfer the customer out of the multimedia communications session until the service request is satisfied.

One of the many contact center resources available to the CCM is an automated human-computer interaction unit with multimedia capabilities. In some embodiments, the automated human-computer interaction unit with multimedia capabilities is described as a video response unit (VidRU). The VidRU provides an automated multimedia interaction with a customer during a customer service request, which includes, but is not limited to, one or more of displaying video and/or textual content to the customer, playing audio content to the customer, displaying a graphical user interface, receiving and interpreting auditory, textual, and/or tactile responses from the customer.

The video content displayed to the customer by the VidRU may include, but is not limited to, pre-recorded video content or live events. In some instances, a portion of the displayed video content appears as a series of menu options. Each menu option may indicate a word or phrase to be spoken by the customer in order to select the respective menu option. Alternatively or additionally, each menu option may appear in the form of a button that may be actuated through physical interaction. In some example embodiments, the VidRU accepts either or both forms of customer interaction, i.e., verbal command and/or physical actuation. When a verbal command and a physical actuation occur simultaneously, protocols may establish preferences such as the physical actuation takes precedence over the verbal command.

Once a customer response has been received during the multimedia interaction, the VidRU interprets the response and displays additional video content in order to assist the customer during the customer service request. This process may be repeated until the service request has been resolved, the CCM determines that addition resources are required to service the customer, the VidRU finishes executing the instructions in a predetermined script, and/or the customer service request is terminated. While the customer is interacting with the VidRU, additional contact center resources may be delivered to the hangout by the CCM in real-time based upon the needs of the customer. Additionally, the VidRU may also be able to detect and accommodate audio-only customer service requests.

In another example embodiment, a contact center platform establishes a cloud-based multimedia interaction with a customer. A customer is permitted to navigate to a contact center through IP selections and connections. Where telephone exchange connections are utilized, the customer may dial a phone number and be connected through a connection manager. In some instances, features of the connection manager handling telephone exchange connections are described as a Contact Center Bell (CCB).

In the contact center platform environment, a user is permitted to establish a multimedia communications session in which two or more individuals may interact in the same virtual location. Such a contact center platform supports diverse communication tools to interact, collaborate, and/or share information. The location established as a virtual hangout is hosted by one or more servers that support communications sessions with user machines equipped with resources such as microphones and video cameras. For example, resources participating in a contact center session may share and watch videos, participate in video, audio, or text chat, surf the web, seek or provide assistance regarding a particular problem, or any combination thereof.

When an individual desires to establish a contact center interaction in a virtual environment, the individual may employ a client device to either initiate a virtual contact center session or join an existing virtual contact center session. When establishing a new virtual contact center session, the individual may be joined by others. Typically, to join an existing virtual contact center session, each participant is invited. Invitations arrive via e-mail, text messaging services, or any other suitable means. An individual can request to join an existing contact center session even though he or she has not received an invitation, assuming the URL for the session is known. Additionally, individuals participating in a virtual contact center session may cause the session to link to external resources and integrate those external resources into the participants' graphical user interface (GUI).

In one example embodiment, a user initiates contact with the contact center platform indicating the desirability of establishing a session. Based on nascent characteristics of the initiation, such as the button pushed, the phone number called, or the phone number dialed, the request may be handled in different manners. For example, in the case of an IP initiation, a contact center manager communicates with a room coordinator to identify a session reference, e.g., a JID, for a new session location. The user is then permitted to establish an individualized contact center session in the virtual environment.

The user is not transferred from the individual contact center session under most circumstances. Instead, resources are directed to the location and then combined into a multimedia or multisource platform. In some example embodiments, resources are derived from different servers such as a media server and then provided to the contact center session. The signals from the user as well as such other resources are collected by a reflector and then consolidated into a single real time protocol (RTP) session comprising multiple independent streams.

For example, in a hypothetical scenario, a user might establish a contact center session with a particular location and identifier, which may comprise a JID or URL or other address. As an initial step, an automated human-computer interaction unit may be directed to the contact center session where it may interact with the user. Depending on the nature of the communication link with the user (audio, audio/video, multimedia, etc), the contact center session and the human-computer interaction unit can send content tailored to the user. At the end of the human-computer interaction, the user might need a contact center agent. Rather than transferring the call, the Contact Center Manager (CCM) initiates a connection between the contact center agent and the contact center session by directing the agent to the session location. When there, depending on the resources of the user, the contact center agent may initiate diverse resources such as video playback, internet access, etc. During the interims, the user is not placed on hold but is permitted to interact in the contact center session where there might be games, and other entertainment. Since the connection of the user to the contact center session is not transferred or otherwise redirected, the connection is very stable. This facilitates much greater stability in the call center session and increases customer satisfaction. In the hypothetical scenario just described, additional contact center resources, e.g., customer service agents, customer service supervisors, customers seeking similar assistance, session recording devices, etc., may be used in addition to or in combination with the automated human-computer interaction unit. In some instances, applying resources to the session in parallel reduces the duration of time required to resolve a customer service request.

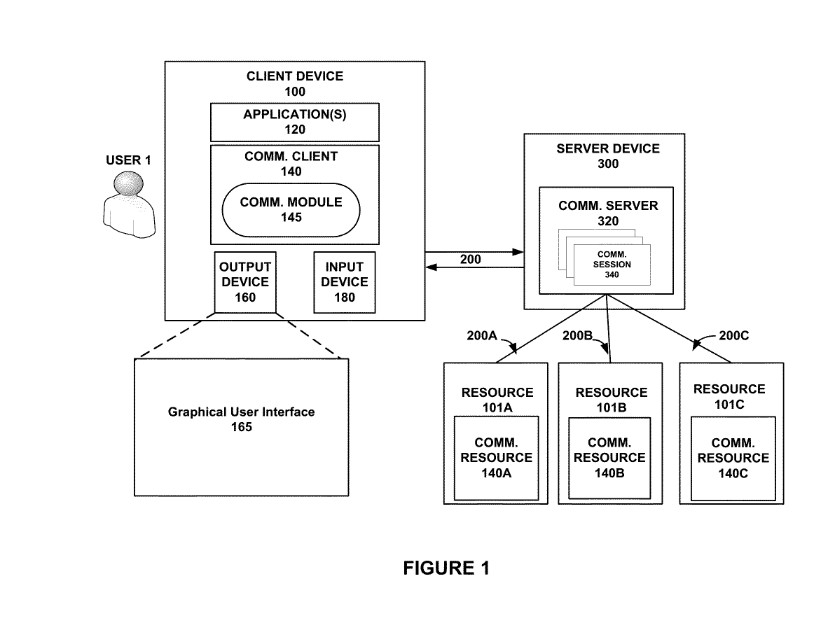

An example multimedia production environment is described in detail with respect to FIGS. 1-4. The illustrated environment is presented as an example, and does not imply any limitation regarding the use of other group networking environments. To the contrary, the description contemplates all implementations of multimedia production environments that route external multimedia resources into and out of multimedia communications sessions in the multimedia production environment.

Turning to FIG. 1, an example client device 100 is connected to a multimedia production environment supporting a call center communications session that enables communication among various resources. Examples of client device 100 include, but are not limited to, portable, mobile, and/or stationary devices such as landline telephones, mobile telephones (including “smart phones”), laptop computers, tablet computers, desktop computers, personal digital assistants (PDAs), portable gaming devices, portable media players, and e-book readers. In some embodiments, two or more client devices may be connected in the same manner to the communication session. Similarly, resource devices 101A-C may include similar communications. For example, client device 100 and resource device 101A may both be mobile telephones. In other embodiments, two or more client and resource devices are different types of devices. For example, client device 100 may be a mobile telephone and resource device 100B may be a desktop computer or other resource residing on and powered by programmed logic circuits.

In the embodiment illustrated by FIG. 1, the client device 100 communicates with a server 300 via a communications channel 200. The communications channel typically includes an Internet connection between the client 100 and the server 300 but could be established by other such communication circuits such closed networks, etc. The server 300 often comprises multiple physical servers such as a communications server 320 for maintaining or “hosting” one or more communications sessions, such as contact center communications session 340. Of course, each server can be a physically separate machine or it can be different processes running within the same physical machine.

In one example embodiment, the client 100 maintains or hosts a contact center communications session and other resource devices such as resource devices 101A-C in FIG. 1 are routed to the communications session at the client 100 by server 300 or the like. Additionally, while depicted as a single device in FIG. 1, in some embodiments server 300 includes a plurality of interconnected devices maintained at different physical locations.

Communications sessions 340 at the communications server 320 are supported by an environment defined by a runtime engine executing at the server. For example, the runtime engine may be Google's “App Engine.” The runtime engine provides the platform for the contact center session and supplies resources required for user interaction. The resources of the application engine are available to the contact center session by way of an application programming interface (API) or other connecting application, transferring protocol or the like. In some instances, multimedia streams are distributed by reflectors distributing combined signals in various protocols such as RTP.

The client 100 of FIG. 1 includes application(s) 120, communications client 140, output device 160 (e.g., a display), and input device 180 (e.g., keyboard, mouse, touch screen). Application(s) 120 provide the client 100 with a variety of functionality. Generally, application(s) 120 employ the output device 160 to display information at a graphical user interface (GUI) 165. In alternative example embodiments, the resources include other persons and application initiated content such as video and broadcast feeds, recordings, etc.

The communications client 140 further includes a communications module 145 that enables output device 160 to display information at the GUI 165. The communications module 145 also enables the communications client 140 to connect to the communications server 320, allowing user 1 in FIG. 1 to establish or join a hangout session. Typically, the communications module 145 is a network module that connects the client 100 to a network such as the Internet using network protocol techniques including by way of example transmission control protocols an internet protocols. The communication resource 140A-C may also include similar functionality as the communications client 140. However, other resources are included in example embodiments such as closed networks and the like which would have alternatives in the communication platforms. In this manner a client 100 and multiple potential resources 101A-C may join the same contact center communications session 340 hosted at the communications server 320. Through the communications session 340, the communications module 145 at the client 100 enables the user 1 to reside in a location where other resources may be provided or may be selected to join the session.

Once a contact center communications session 340 is established, a session channel 200 between the communications client 140 and the communications server 320 exchanges data, such as audio, video, text, and/or other information. In some embodiments, the data exchanged between the communications client 140 and the communications server 320 is optimized based, at least in part, on the hardware and/or software capabilities of client device 100. For example, if the client 100 is a mobile device connecting through to the session 340 by way of a bandwidth limited path such as a cellular network, communications server 320 may optimize the number and quality of the audio, video, text, and/or other information sent to client device 100. Furthermore, communications client 140 may dynamically adjust the bit rate required to send the information to communications server 320 by, for example, reducing the quality of the audio, video, text, and/or other information being sent to communications server 320.

GUI 165 is an illustrative example of a GUI from which a contact communications session may be initiated and sustained. In the illustrated embodiment, GUI 165 includes information about one or more other resources connected to user 1 by the contact center communications session 340. The GUI may also include information about other resources user 1 may access, notifications of events and other information relevant to user 1.

In order to establish or join a contact center communications session, user 1 interacts with GUI 165 to cause communications client 140 to generate a request to create a new communications session 340 or join an existing communications session. For example, GUI 165 may include a “Get Help” button that user 1 activates in order to create a new contact center communications session. In response to user 1 activating the Get Help button, communications client 140 sends a request to initiate a new communications session 340 to communications server 320, which establishes a new contact center communications session.

As the new session is initiated, various resources, such as resources 101A-C in FIG. 1, may be directed to the session as needed without the user being transferred. For example, an automated human-computer interaction unit may be initiated as a resource 101A. The unit may permit the user to see and hear communications directed at identifying and solving the help issues identified by the user 1. As the unit provides its resource, a contact center manager can receive information that is processed to determine other resources 1B-C that should be provided. As the resources are provided, the user 1 is not required to have disruption of service.

In one alternative example embodiment, user 1 may request join an existing contact center communications session 340 or the contact center manager may determine that the user should be joined to an existing session. In such example embodiment, the contact center manager includes business rules and other information such as other open sessions. Based upon information provided by the user which may be explicit, such as by responding to a prompt, or implicit, such as selecting a certain entry point, the contact center manager may communicate with the communications server 320 to join the user to a communications session 340 already ongoing.

In another alternative, the user 1 selects a “join prior contact center link” icon at the GUI 165 and selects a session from a displayed list of available contact center sessions at the GUI or selects a “join contact center link” icon displayed in an external source such as an instant message or posting. However communicated to the user 1, in response to user 1 initiating an attempt to join an existing virtual hangout session, communications client 140 sends a request to join the communications session 340 to the communications server 320. The request includes an identifier of the particular communications session 340 associated with the contact center session. The identifier may be included in the join link for the virtual contact center. Communications server 320 connects communications client 140 to the specified communications session 340.

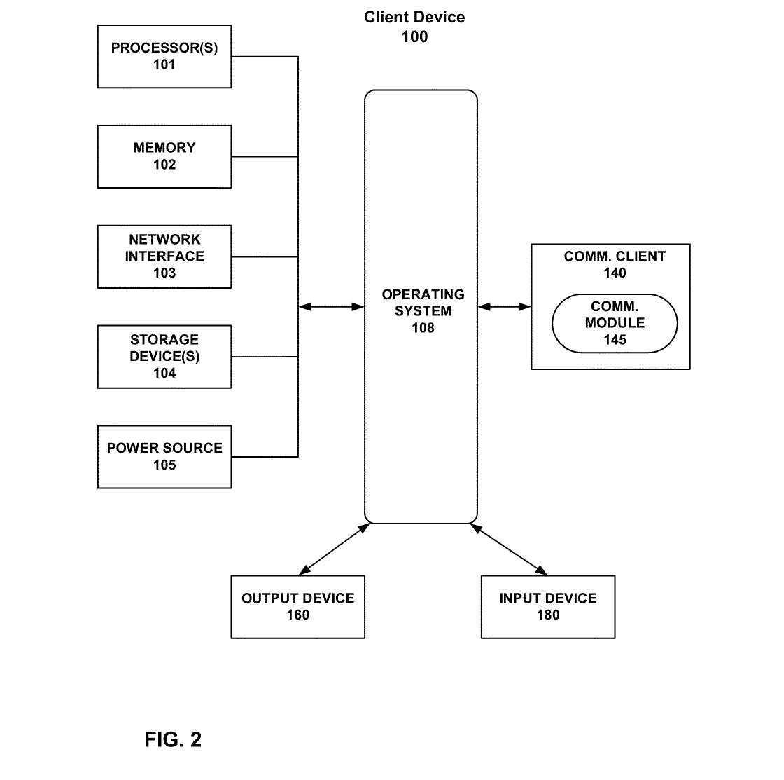

Referring now to FIG. 2, one example of client device 100 is illustrated. In general, many other embodiments of the client 100 may be used as long as they support at least limited participation in the hangout sessions. In the example embodiment of FIG. 2, the client 100 includes one or more processors 106, memory 102, a network interface 103, one or more storage devices 104, power source 105, output device 160, and input device 180. The client 100 also includes an operating system 108 and a communications client 140 that are executable by the client. In a conventional fashion, each of components 106, 102, 103, 104, 105, 160, 180, 108, and 140 are interconnected physically, communicatively, and/or operatively for inter-component communications.

As illustrated, processors 106 are configured to implement functionality and/or process instructions for execution within client device 100. For example, processors 106 execute instructions stored in memory 102 or instructions stored on storage devices 104. Memory 102, which may be a non-transient, computer-readable storage medium, is configured to store information within client 100 during operation. In some embodiments, memory 102 includes a temporary memory, area for information not to be maintained when the client 100 is turned off. Examples of such temporary memory include volatile memories such as random access memories (RAM), dynamic random access memories (DRAM), and static random access memories (SRAM). Memory 102 is maintains program instructions for execution by the processors 106.

Storage devices 104 also include one or more non-transient computer-readable storage media. Storage devices 104 are generally configured to store larger amounts of information than memory 102. Storage devices 104 may further be configured for long-term storage of information. In some examples, storage devices 104 include non-volatile storage elements. Non-limiting examples of non-volatile storage elements include magnetic hard discs, optical discs, floppy discs, flash memories, or forms of electrically programmable memories (EPROM) or electrically erasable and programmable (EEPROM) memories.

The client 100 uses network interface 103 to communicate with external devices via one or more networks, such as one or more wireless networks. Network interface 103 may be a network interface card, such as an Ethernet card, an optical transceiver, a radio frequency transceiver, or any other type of device that can send and receive information. Other non-limiting examples of network interfaces include Bluetooth®, 3G and WiFi® radios in mobile computing devices, and USB. In some embodiments, the client 100 uses network interface 103 to wirelessly communicate with an external device such as the server device 300 of FIG. 1, a mobile phone, or other networked computing device.

The client 100 includes one or more input devices 180. Input device 180 is configured to receive input from a user through tactile, audio, and/or video feedback. Non-limiting examples of input device 180 include a presence-sensitive screen, a mouse, a keyboard, a voice responsive system, video camera, microphone or any other type of device for detecting a command from a user. In some examples, a presence-sensitive screen includes a touch-sensitive screen.

One or more output devices 160 are also included in client device 100. Output device 160 is configured to provide output to a user using tactile, audio, and/or video stimuli. Output device 160 may include a display screen (part of the presence-sensitive screen), a sound card, a video graphics adapter card, or any other type of device for converting a signal into an appropriate form understandable to humans or machines. Additional examples of output device 160 include a speaker, a cathode ray tube (CRT) monitor, a liquid crystal display (LCD), or any other type of device that can generate intelligible output to a user.

The client 100 includes one or more power sources 105 to provide power to the client. Examples of power source 105 include single-use power sources, rechargeable power sources, and/or power sources developed from nickel-cadmium, lithium-ion, or other suitable material.

The client 100 includes an operating system 108 such as the Android® operating system. The operating system 108 controls operations of the components of the client 100. For example, the operating system 108 facilitates the interaction of communications client 140 with processors 106, memory 102, network interface 103, storage device(s) 104, input device 180, output device 160, and power source 105. As illustrated in FIG. 2, communications client 140 includes communications module 145. Each of communications client 140 and communications module 145 typically includes program instructions and/or data that are executable by the client 100. For example, in one example embodiment communications module 145 includes instructions causing the communications client 140 executing on the client 100 to perform one or more of the operations and actions described in the present disclosure.

In some example embodiments, communications client 140 and/or communications module 145 form a part of operating system 108 executing on the client 100. In other embodiments, communications client 140 receives input from one or more of the input devices 180 of the client 100. Communications client 140 preferably receives audio and video information associated with a communications session 340 from other client devices participating in the communications session.

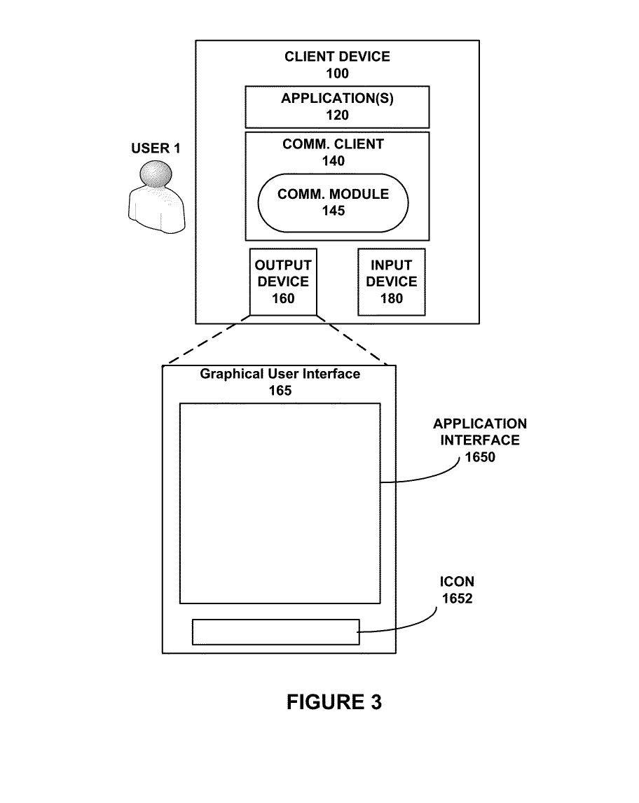

FIG. 3 illustrates an example configuration of the client 100 when it seeks to generate a contact center session. The communications module 140 initiates a contact center session from the client 100 and maintains the session with the communications session 340 at the server 320. As shown in FIG. 3, GUI 165 displays application interface 1650 which may provide access to resources 101A-C as examples. Application interface 1650 may also allow user 1 to use and interact with application(s) 120, which in one embodiment can be a internet browser such as Google Chrome. In some examples, application interface 1650 is a graphical display that is not interactive.

The communications module 145 causes GUI 165 to display a user-selectable icon 1652. Non-limiting examples of the icon 1652 are a virtual or graphical button, such as a key of a virtual keyboard, a touch-target, a physical button of client device 100, or a button on an input device 180 coupled to client device 100, such as a mouse button, a button on a mobile device, or a key of a keyboard. Of course, GUI 165 may include other graphical controls as well.

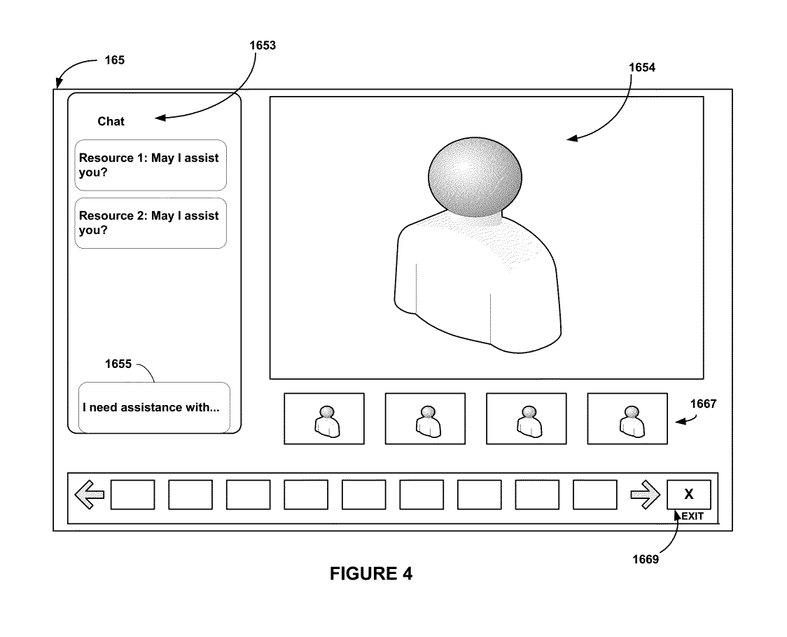

The graphical user interface (GUI) of FIG. 4 is an example of the GUI 165 of client 100 such as in FIGS. 1 and 3. However, the graphical display of FIG. 4 may be outputted using other devices. A client application supporting contact center sessions is typically web-based contained within an internet browser session. The application exposes a number of features to the user through the GUI. These graphically displayed features include a video display 1654 of one or more resources in the session. A chat feature 1653 may be provided, including a chat history and a field 1655 where a user can, such as user 1, input text to the chat conversation. GUI 165 is also configured to display graphical images 1667 that are associated with resources or agents in the session. Graphical images 1667 may include images of agents currently participating in the contact center session. Exit button 1669 is provided as an example of a way in which the user may terminate the contact center communications session if desired.

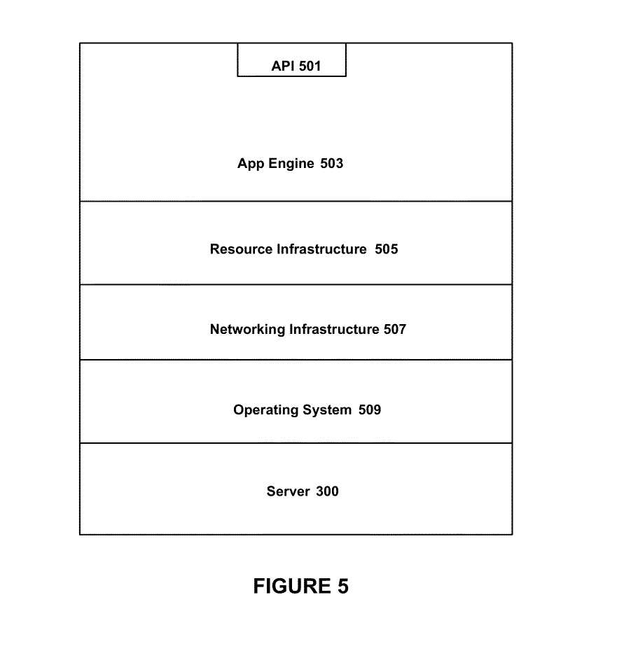

Referring to FIG. 5, in one example embodiment, an application programming interface (API) 501 of an Application Engine or App Engine 503 provides many resources or agents to the communications session 340 (e.g., a hangout session). As an alternative, the contact center manager may direct the connection of such resources or agents to the communications session 340. In turn, the App engine 503 may utilize resources provided from an API exposed by an resources infrastructure layer 505 and a networking layer 507, which are supported by the servers 300 and their operating systems 509. The App Engine 503 and the resource infrastructure layer 505 connect HTTP requests from the user to the communications sessions 340. The App engine 503 also provides a runtime environment for the communications sessions 340. Administrative support for the communications sessions 340 may be provided by the a contact center manager in the App engine 503. The App engine 503 also provides access to a database in the resource infrastructure layer 505 for persistent storage requirements of the communications sessions 340.

Through its API 501, the App engine 503 provides the communications sessions 340 access to resources on the Internet, such as web services or other data. The App engine 503 retrieves web resources using the resource infrastructure layer 505. The communications session 340 also sends and receives messages using the App engine 503 and the resource infrastructure layer 505. The App engine 503 and the resource infrastructure layer 505 also supports a cache, which is useful for temporary data or data copied from the datastore to the cache for high speed access. The resource infrastructure layer 505 also supports a file system and scheduling resources. An example of the App Engine, Google's App Engine. An example of the resource infrastructure layer 505, the networking infrastructure 507 and the operating system 509 is Google's supporting infrastructure and operating system for its App engine.

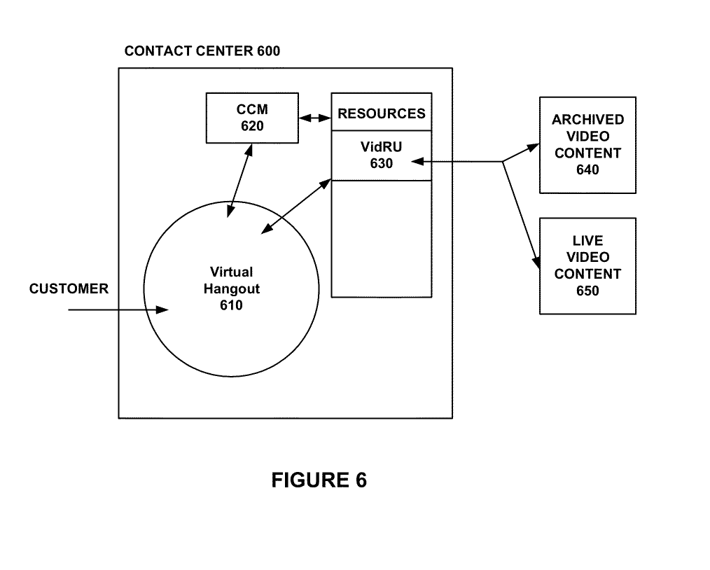

FIG. 6 is block diagram illustrating example resources available for use in a virtual hangout being used as a point of contact (POC) to assist a customer during a service request. One of the resources depicted in FIG. 6 is an automated human-computer interaction unit with multimedia capabilities, which, in some instances, may be described as a video response unit (“VidRU”). In some embodiments, a VidRU executes a script to provide the participant(s) in the virtual hangout with additional multimedia content. Additional multimedia content includes, but is not limited to, displaying video and/or textual content to the participant(s), playing audio content to the participant(s), and displaying a graphical user interface to the participant(s), and/or any combination thereof. In some embodiments, a VidRU presents audio and textual content as video content in a virtual hangout. In these embodiments, the participant(s) experience audio and textual content in the same manner as video content. Further, a VidRU may include text-to-speech (TTS) functionality. Thus, textual content presented to the participant(s) may, alternatively or additionally, be presented as audio content using TTS. This functionality allows individuals using telephone exchange connections, vision impaired individuals, and/or individuals looking away from displayed text to participate in certain aspects of a virtual hangout session. Additionally, the VidRU is configured to receive and interpret input from the participants. Input from the participants includes, but is not limited to, auditory, textual, and/or tactile input.

As depicted in FIG. 6, the contact center 600 may monitor the virtual hangout 610 using an automated management tool, such as the contact center manager (CCM) 620 in FIG. 6, to determine the recourses necessary to assist the customer. The VidRU 630 is one of the many contact center resources, e.g., customer service agents, customer service supervisors, etc., available for the CCM 620 to use in the virtual hangout 610 to assist the customer. In this embodiment, the VidRU 630 may access archived video content 640 and/or live video content 650 to provide video content to the participants of the virtual hangout 610. In some embodiments, archived video content 640 includes YouTube and the like.

In this embodiment, the CCM 620 instructs and/or sends a request signal to the VidRU 630 to associate with the virtual hangout 610. In alternative embodiments, the customer or other individuals participating in the virtual hangout 610, instruct the VidRU 630 to associate with the virtual hangout 610. Upon receiving an instruction to associate, the VidRU 630 executes a predetermined script in order to interact with the participants of the virtual hangout 610. In some example embodiments, the script is a VXML document. In some embodiments, the contact center 600 includes a reflector (not shown) that consolidates, into a single RTP session comprising multiple independent streams, the content transferred between the client device and the VidRU 630.

In some example instances, the CCM 620 associates the VidRU 630 with the virtual hangout 610 at the beginning of a customer service request in order to extract attributes. Attributes include, but are not limited to, personal information about the customer (e.g., name, account number, account status, etc.), the products or services that customer is requesting assistance with, or any other information that may be helpful to determine the cause of the service request and the additional resources required to satisfy the request. Of course, the CCM 620 may associate the VidRU 630 with the virtual hangout 610 at any time throughout the duration of the service request in order to extract attributes. Additionally, the CCM 620 may use the VidRU 630 to entertain or distract customers during periods of time where they are waiting for other resources to become available. The same resources may be allocated when the customer joins a session already in progress or already scheduled. Further, in the embodiments, the various components may be integrated into a single platform while maintaining their individual functionality and identity, such platform may be a single server or distributed applications working as a single unit.

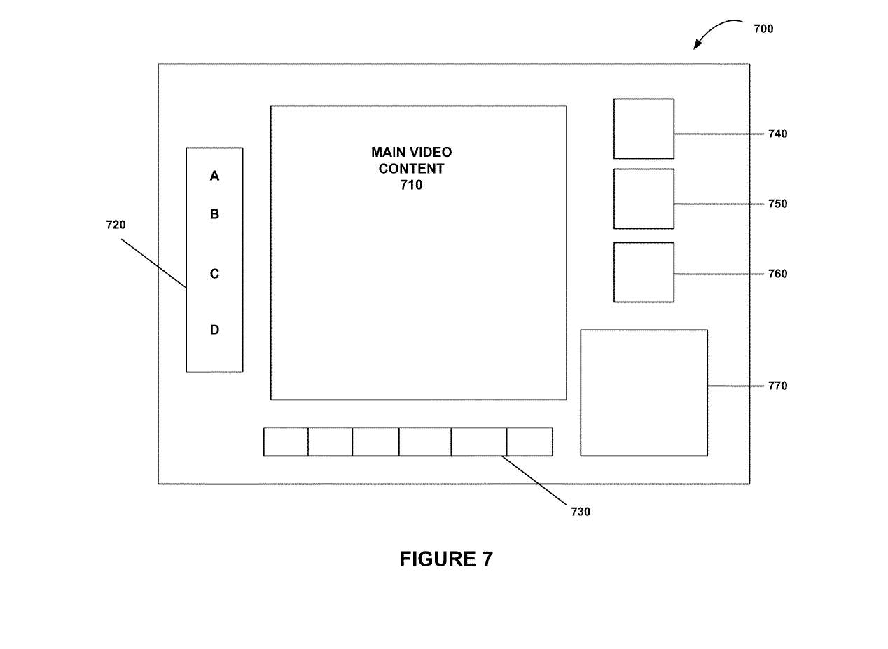

In some instances, a portion of the video content displayed by the VidRU 630 appears as a GUI including a series of menu options. FIG. 7 illustrates one example of a GUI that may be displayed by a VidRU on a graphical user interface of a client such as depicted in FIG. 1 as GUI 165. In FIG. 7, GUI 700 includes main video content 710, client selections portion 720, menu option(s) 730, and text input portion 770. In some embodiments, GUI 700 is displayed to the participants of a virtual hangout once a VidRU is associated with the hangout and begins executing.

Main video content 710 includes video content that the VidRU presents to the participant(s) of a virtual hangout. As described above, main video content 710 includes, but is not limited to, archived video content, live video content, and/or a combination thereof. In some instances, TTS is used to generate audio content from textual content for recordation and play-back or for playing in real-time. In these instances, the VidRU is configured to play the audio while displaying textual content, which appears as video content, e.g., main video content 710. In one example, in the context of a virtual hangout being used as a POC to assist a customer during a service request, main video content 710 includes an instructional video to assist the customer with specific service requests. In some instances, the instructional video is pre-recorded and archived. As an alternative, the instructional video is a live video feed of a customer service agent. Additionally, main video content 710 may display text. Thus, in some instances, text comprising a series of instructions to assist the customer appear, alone or in combination with additional video content, as main video content 710. In some embodiments, the VidRU interprets text comprising instructions using TTS to generate audio. The audio and/or textual content is then presented as main video content 710. In these embodiments, the VidRU “reads” the instructions to the customer.

In an example embodiment, one or more customer selection options 720 are provided where the user may select or offer feedback. If the user selects such areas, signals may be distributed to all or some of the resources to indicate information relating to the user. Such information may be utilized by the API or other applications to further control content being provided to the user. For example, if the user selects A is customer selection options 720, the CCM may direct that different resources be added to the hangout.

Customer selection options 720 may also provide a mechanism for the participant(s) of a virtual hangout to interact with the VidRU that is generating GUI 700. In this embodiment, the VidRU is configured to receive and interpret input from the participant(s) via one or more client devices. Input from the participants includes, but is not limited to, auditory, textual, and/or tactile input. As described in accordance with FIG. 1, individuals may use a variety of client devices to participate in a virtual hangout. Client devices include, but are not limited to, portable, mobile, and/or stationary devices such as landline telephones, mobile telephones (including “smart phones”), laptop computers, tablet computers, desktop computers, personal digital assistants (PDAs), portable gaming devices, portable media players, and e-book readers. In this embodiment, the VidRU is able to detect the forms of input each client device is configured to support. Alternatively, each client device notifies the VidRU of the forms of input that each client device, respectively, is configured to support.

In this embodiment, each of menu option(s) 730 displayed by GUI 700 indicate a word or phrase that may be spoken by the participant(s) of a virtual hangout in order to select respective menu option(s) 730. For example, an individual participating in the virtual hangout may speak into a client device comprising a microphone to select one or more of menu option(s) 730. The VidRU receives and interprets the spoken words. In this embodiment, the VidRU executes a series of instructions, i.e. a script, based upon the verbal responses and selections made by the participant(s). For example, menu option(s) 730 may include the words “stop” and “play”. Thus, a participant may speak one of these words to instruct VidRU to either stop playback or begin playback of the main video content 710. In some instances, an individual participating in the virtual hangout may verbally respond to text displayed in main video content 710 to instruct the VidRU.

Alternatively or additionally, when a client device supports tactile input, each of menu option(s) 730 displayed by GUI 700 may appear in the form of a button that is actuated by tactile input. For example, an individual participating in the virtual hangout touches a portion of the screen of a client device comprising a touch-sensitive screen to select a menu option. Again, the VidRU executes one or more instructions based upon the button selected by the tactile input. In some instances, an individual participating in the virtual hangout interacts with a VidRU by inputting text, using e.g., one of the input devices described in conjunction with FIGS. 1-4, into text input portion 770.

In some embodiments, a VidRU accepts both forms of input, i.e., auditory input and tactile input to select menu option(s) 730. In these embodiments, when auditory and tactile input occur simultaneously, the VidRU only responds to the tactile input. Alternatively, when auditory and tactile input occur simultaneously, the VidRU responds to the tactile input first, followed by the auditory input.

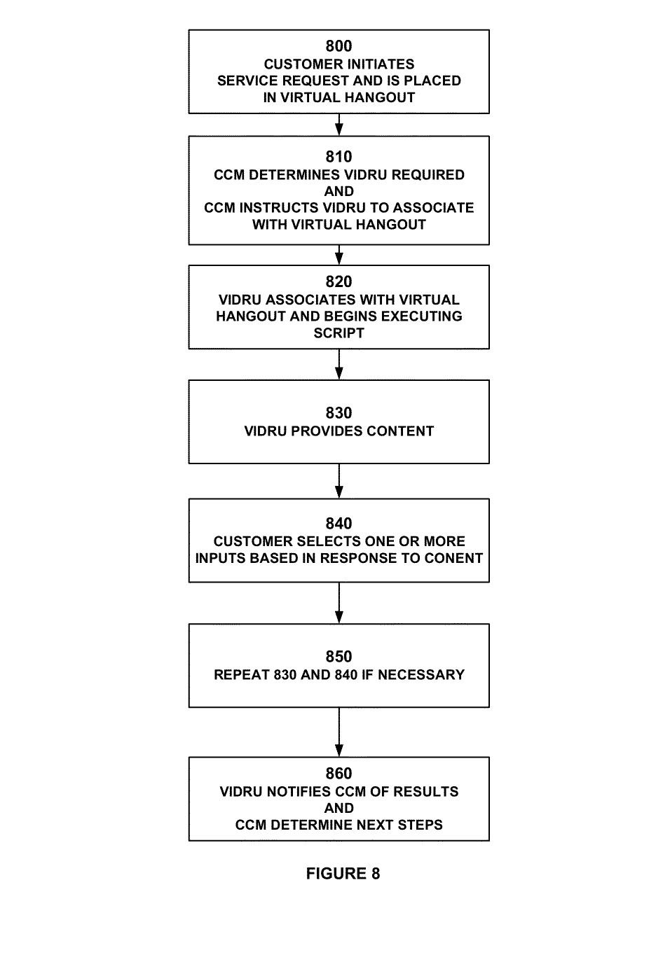

FIG. 8 describes a method of assisting a customer during a service request in a multimedia production environment using the VidRU described in FIGS. 6 and 7. The method of FIG. 8 includes:

Step 800: The contact center receives the service request initiated by the customer and places the customer into a virtual hangout session. Each virtual hangout session is identified and referenced using a unique identifier, e.g., a JID or URL. In some embodiments, the CCM described in FIG. 6 establishes and monitors all active and inactive virtual hangout sessions maintained by the contact center. In these embodiments, the CCM receives notification at step 800 that a new service request was received at the contact center. In response, the CCM may either establish a new virtual hangout session or route the customer to an existing virtual hangout session.

Step 810: The CCM determines that a VidRU is required to assist the customer. The CCM instructs a VidRU to associate with the virtual hangout session that the customer is participating in. In some embodiments, CCM instructs the VidRU to associate with a particular virtual hangout session by passing the session's unique identifier to the VidRU.

Step 820: The VidRU associates with the appropriate virtual hangout session begins to execute its script, e.g., a VXML document.

Step 830: The VidRU provides archived and/or live video content to the customer in the virtual hangout session.

Step 840: The customer, via one or more of the client devices described in accordance with FIGS. 1-4, receives input options from the VidRU and responds through verbal, textual, and/or tactile input supported by the client device. The VidRU receives and interprets the input from the client device and responds as required by the script. Example responses include, but are not limited to, ending the interaction, providing additional video content, providing the CCM with a status update or other information, requesting that the CCM transfers additional resources into the virtual hangout session, and providing additional input options to the customer.

Step 850: Optional—The customer, via the client device, and the VidRU continue to interact as described in step 840 until the VidRU completes its script or the interaction is terminated.

Step 860: The VidRU notifies the CCM of the result of the interaction. The CCM decides whether additional resources are required to assist the customer or whether to terminate the service request.

While the VidRU is configured to support multimedia interactions, it may also configured to interact with client devices that only support limited forms of communication, e.g., a landline telephone. In these embodiments, the VidRU may execute a different set of instructions that are directed to interacting with such client devices.

In the example embodiments, the various applications can be configured on any distributed or embedded platform within a single location or multiple locations. For example, the CCM may be resident on an individual and separate platform or may be embedded into a server platform. Similarly, some of the resources may reside on individual and separate platforms or they may be embedded into the server or other platforms. As such, embodiments contemplate that applications, resources, managers, servers, etc. may be joined or separated without diverging from their identities and functions.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or example language (e.g., “such as”) provided herein, is intended merely to better illuminate the embodiments and does not pose a limitation on the scope of the invention unless otherwise claimed. No language in the specification should be construed as indicating any non-claimed element as essential to the practice of the invention.

Embodiments of this invention are described herein, including the best mode known to the inventors for carrying out the invention. Variations of those embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1-20. (canceled)

21. A server system comprising non-transitory computer readable storage media for providing a video response resource over a multimedia stream to a client device, the server system comprising:
a platform configured to host a communication session to which video content resources can be delivered and at which the video content resources can be consolidated;
a contact center manager configured to:
receive a customer service request sent by a client device,
identify a location of the platform,
establish, at the platform, the communication session, and
direct an automated multimedia interaction unit to associate with the communication session; and
the automated multimedia interaction unit configured to:
access the video content resources, deliver the video content resources to the communication session,
provide, to the client device from the communication session via a session channel between the client device and the communication session, first streaming video content including a plurality of choices for output by the client device,
receive an indication of a selection of one or more of the plurality of choices, the selection relating to an additional video content resource not delivered to the communication session, and
provide, to the client device via the session channel, second streaming video content in response to receiving the indication.

22. The server system of claim 21, wherein the contact center manager is further configured to deliver a contact center agent video resource to the communication session, and
wherein the automated multimedia interaction unit is further configured to:
combine the contact center agent video resource with one or more of the video content resources, and
provide, to the client device via the session channel as at least a part of the second streaming video content, the combination of the contact center agent video resource and the one or more of the video content resources.

23. The server system of claim 22, wherein the platform configured to host the communication session to which video content resources can be delivered and at which video content resources can be consolidated is provided by a runtime engine.

24. The server system of claim 22, wherein delivering the contact center agent video resource to the communication session comprises providing an address that identifies a location, within the server system, of the communication session to the contact center agent.

25. The server system of claim 21, wherein the resources delivered to and consolidated at the communication session are determined, at least in part, on one or more of the group consisting of: hardware capabilities of the client device and software capabilities of the client device.

26. The server system of claim 21, wherein the automated multimedia interaction unit is further configured to:
provide, to the client device via the session channel, textual content and audio content, and
receive and interpret input provided from the client device.

27. (canceled)

28. The server system of claim 21, wherein the contact center manager is configured to direct the automated multimedia interaction unit to associate with the communication session at a beginning of the customer service request.

29. The server system of claim 21, wherein the automated multimedia interaction unit executes a predetermined script in order to interact with the client device.

30. The server system of claim 29, wherein the predetermined script is a voice extensible markup language (VXML) document.

31. A method for providing, by a server system comprising a non-transient computer readable medium, a video response resource over a multimedia stream to a client device, the method comprising:
receiving a customer service request sent by a client device;
identifying a location of a platform configured to host a communication session to which video resources can be delivered and at which the video content resources can be consolidated;
establishing, at the platform, the communication session;
directing an automated multimedia interaction unit to associate with the communication session;
accessing the video content resources;
delivering the video content resources to the communication session;
consolidating the video content resources at the communication session;
providing, to the client device from the communication session via a session channel between the client device and the communication session, first streaming video content to the client including a plurality of choices for output by the client device;
receiving an indication of a selection of one or more of the plurality of choices, the selection relating to an additional video content resource not delivered to the communication session; and
providing, to the client device via the session channel, second streaming video content in response to receiving the indication.

32. The method of claim 31, further comprising delivering a contact center agent video resource to the communication session.

33. The method of claim 32, wherein the platform configured to host the communication session to which video content resources can be delivered and at which video content resource can be consolidated is provided by a runtime engine.

34. The method of claim 32, wherein directing the contact center agent video resource to associate with the communication session comprises providing an address that identifies a location, within the server system, of the communication session to the contact center agent.

35. The method of claim 31, further comprising determining the resources delivered to the communication session from one or more of the group consisting of: hardware capabilities of the client device and software capabilities of the client device.

36. The server system of claim 31, further comprising;
providing textual content to the client device;
providing audio content to the client device; and
receiving and interpreting input provided to the client device.

37. The server system of claim 31, further comprising associating a multimedia interaction unit with the communication session.

38. The server system of claim 37, wherein associating the multimedia interaction unit with the communication session is performed immediately after establishing, at the platform, the communication session.

39. A non-transitory computer readable medium having stored thereon instructions for providing a video response resource over a multimedia stream to a client device, the instructions comprising instructions for:
receiving a customer service request sent by a client device;
identifying a location of a platform configured to host a communication session to which video resources can be delivered and at which the video content resources can be consolidated;
establishing, at the platform, the communication session;
directing an automated multimedia interaction unit to associate with the communication session;
accessing the video content resources;
delivering the video content resources to the communication session;
consolidating the video content resources at the communication session;
providing, to the client device from the communication session via a session channel between the client device and the communication session, first streaming video content to the client including a plurality of choices for output by the client device;
receiving an indication of a selection of one or more of the plurality of choices, the selection relating to an additional video content resource not delivered to the communication session; and
providing, to the client device via the session channel, second streaming video content in response to receiving the indication.

40. The non-transitory computer readable medium of claim 39, the instructions further comprising instructions for:
delivering a contact center agent video resource to the communication session.

41. The server system of claim 21, wherein the contact center manager is further configured to:
deliver, while the automated multimedia interaction unit is providing, to the client device via the session channel, one of the first streaming video content or the second video content, additional video resources to the communication session.
